(19) United States
(12) Patent Application Publication
(10) Pub. No.: US 2004/0105165 A1
(43) Pub. Date: Jun. 3, 2004

(54) Zoom lens system

(75) Inventor: Takashi Enomoto, Chiba (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/721,090

(22) Filed: Nov. 26, 2003

(30) Foreign Application Priority Data
Nov. 29, 2002 (JP) 2002-348571

(51) Int. Cl. G02B 15/14

(52) U.S. Cl. 359/686

(57) ABSTRACT

A zoom lens system includes a positive first lens group, a negative second lens group, a positive third lens group, and a negative fourth lens group. Zooming is performed by moving each of the positive first through the negative fourth lens groups along the optical axis.

The zoom lens system satisfies the following conditions:

0.5<(D_{12T}−D_{12W})/f_{W}<1.0 (1)

1.0<ΔX_{1G}/ΔX_{4G}<1.5 (2)

wherein

D_{12T}: the axial distance between the positive first lens group and the negative second lens group at the long focal length extremity;

D_{12W}: the axial distance between the positive first lens group and the negative second lens group at the short focal length extremity;

f_{W}: the focal length of the entire the zoom lens system at the short focal length extremity;

ΔX_{1G}: the traveling distance of the positive first lens group from the short focal length extremity to the long focal length extremity; and

ΔX_{4G}: the traveling distance of the negative fourth lens group from the short focal length extremity to the long focal length extremity.

### BACKGROUND OF THE INVENTION

1. Field of the Invention

The present invention relates to a zoom lens system for photographic camera, and in particular, relates to a zoom lens system for a lens-shutter camera.

2. Description of the Prior Art

Unlike a zoom lens system of a single lens reflex (SLR) camera which requires space to accommodate a quick-return mirror behind the photographing lens system, a zoom lens system of a compact camera does not require a long back focal distance. As an example of such a zoom lens system of a compact camera having few constrains on the back focal distance, a zoom lens system of a three-lens-group arrangement, i.e., a positive lens group, another positive lens group, and a negative lens group, in this order from the object, has been proposed (e.g., Japanese Unexamined Patent Publication No. Hei-2-256015). However, if an attempt is made to further increase the zoom ratio in such a zoom lens system mentioned above, the overall length of the zoom lens system becomes longer at the long focal length extremity.

Furthermore, for the purpose of achieving further miniaturization and a higher zoom ratio, a zoom lens system of a four-lens-group arrangement, i.e., a positive lens group, a negative lens group, a positive lens group and a negative lens group, in this order from the object, has been proposed (e.g., Japanese Unexamined Patent Publications No. Hei-6-265788 and No. 2000-180725). However, in such a lens arrangement, the traveling distances of the lens groups thereof are longer, so that the overall length of the zoom lens system at the long focal length extremity becomes longer; and the entrance pupil position becomes distant at the short focal length extremity, so that the frontmost lens diameter becomes larger. Consequently, further miniaturization cannot be achieved.

### SUMMARY OF THE INVENTION

The present invention provides a zoom lens system, for a lens-shutter camera with a retractable lens barrel, having a zoom ratio Z (=f_{T}/f_{W}) of more than 4.5, and in particular, having the half angle-of-view of more than 350 at the short focal length extremity.

According to the present invention, there is provided a zoom lens system including a first lens group having a positive refractive power (hereinafter, positive first lens group), a second lens group having a negative refractive power (hereinafter, negative second lens group), a third lens group having a positive refractive power (hereinafter, positive third lens group), and a fourth lens group having a negative refractive power (hereinafter, negative fourth lens group), in this order from the object.

Zooming is performed by moving each of the positive first through the negative fourth lens groups along the optical axis.

The zoom lens system satisfies the following conditions:

0.5<(D_{12T}−D_{12W})/f_{W}<1.0 (1)

1.0<ΔX_{1G}/ΔX_{4G}<1.5 (2)

wherein

D_{12T} designates the axial distance between the positive first lens group and the negative second lens group at the long focal length extremity;

D_{12W} designates the axial distance between the positive first lens group and the negative second lens group at the short focal length extremity;

f_{W} designates the focal length of the entire the zoom lens system at the short focal length extremity;

ΔX_{1G} designates the traveling distance of the positive first lens group from the short focal length extremity to the long focal length extremity; and

ΔX_{4G} designates the traveling distance of the negative fourth lens group from the short focal length extremity to the long focal length extremity.

The zoom lens system preferably satisfies the following condition:

0.1<f_{W}/f_{1G}<0.3 (3)

wherein

f_{W} designates the focal length of the entire the zoom lens system at the short focal length extremity; and

f_{1G} designates the focal length of the positive first lens group.

The zoom lens system can satisfy the following condition:

0.05<(D_{23W}−D_{23T})/f_{W}<0.15 (4)

wherein

D_{23W} designates the axial distance between the negative second lens group and the positive third lens group at the short focal length extremity;

D_{23T} designates the axial distance between the negative second and the positive third lens group at the long focal length extremity; and

f_{W} designates the focal length of the entire the zoom lens system at the short focal length extremity.

The zoom lens system preferably satisfies the following condition:

0.1<(f_{23T}/f_{23W})/(f_{T}/f_{W})<0.4 (5)

wherein

f_{23T} designates the combined focal length of the negative second lens group and the positive third lens group at the long focal length extremity;

f_{23W} designates the combined focal length of the negative second lens group and the positive third lens group at the short focal length extremity;

f_{T} designates the focal length of the entire the zoom lens system at the long focal length extremity; and

f_{W} designates the focal length of the entire the zoom lens system at the short focal length extremity.

The zoom lens system can satisfy the following condition:

1.15<h_{3G}/h₁<1.30 (6)

wherein

h₁ designates the height of paraxial light ray, from the optical axis, being incident on the most object-side surface of the positive first lens group at the short focal length extremity; and

h_{3G} designates the height of the paraxial light ray, from the optical axis, being incident on the most image-side surface of the positive third lens group at the short focal length extremity, when the paraxial light ray has been incident at the height of h1 on the most object-side surface of the positive first lens group.

In the zoom lens system, the positive third lens group preferably includes at least one aspherical surface which satisfies the following condition:

−30<ΔI_{ASP}<−10 (7)

wherein

ΔI_{ASP} designates the amount of change of the spherical aberration coefficient due to the aspherical surface in the positive third lens group under the condition that the focal length at the short focal length extremity is converted to 1.0.

In the zoom lens system, the negative fourth lens group preferably includes at least one aspherical surface which satisfies the following condition:

0<ΔV_{ASP}<3 (8)

wherein

ΔV_{ASP} designates the amount of change of the distortion coefficient due to the aspherical surface in the negative fourth lens group under the condition that the focal length at the short focal length extremity is converted to 1.0.

The present disclosure relates to subject matter contained in Japanese Patent Application No.2002-348571 (filed on Nov. 29, 2002) which is expressly incorporated herein in its entirety.

### BRIEF DESCRIPTION OF THE DRAWINGS

The present invention will be discussed below in detail with reference to the accompanying drawings, in which:

FIG. 1 is a lens arrangement of the zoom lens system according to a first embodiment of the present invention;

FIGS. 2A, 2B, 2C and 2D show aberrations occurred in the zoom lens system shown in FIG. 1 at the short focal length extremity;

FIGS. 3A, 3B, 3C and 3D show aberrations occurred in the zoom lens system shown in FIG. 1 at the intermediate focal length when the lens groups are moved along the lens-group moving paths shown in FIG. 15;

FIGS. 4A, 4B, 4C and 4D show aberrations occurred in the zoom lens system shown in FIG. 1 at the long focal length extremity;

FIG. 5 is a lens arrangement of the zoom lens system according to a second embodiment of the present invention;

FIGS. 6A, 6B, 6C and 6D show aberrations occurred in the zoom lens system shown in FIG. 5 at the short focal length extremity;

FIGS. 7A, 7B, 7C and 7D show aberrations occurred in the zoom lens system shown in FIG. 5 at the intermediate focal length when the lens groups are moved along the lens-group moving paths shown in FIG. 15;

FIGS. 8A, 8B, 8C and 8D show aberrations occurred in the zoom lens system shown in FIG. 5 at the long focal length extremity;

FIG. 9 is a lens arrangement of the zoom lens system according to a third embodiment of the present invention;

FIGS. 10A, 10B, 10C and 10D show aberrations occurred in the zoom lens system shown in FIG. 9 at the short focal length extremity;

FIGS. 11A, 11B, 11C and 11D show aberrations occurred in the zoom lens system shown in FIG. 9 at the first (before switching) intermediate focal length in the short-focal-length side zooming range when the lens groups are moved along the lens-group moving paths shown in FIG. 14;

FIGS. 12A, 12B, 12C and 12D show aberrations occurred in the zoom lens system shown in FIG. 9 at the second (after switching) intermediate focal length in the long-focal-length side zooming range when the lens groups are moved along the lens-group moving paths shown in FIG. 14;

FIGS. 13A, 13B, 13C and 13D show aberrations occurred in the zoom lens system shown in FIG. 9 at the long focal length extremity;

FIG. 14 is the schematic view of the lens-group moving paths, with the switching movement of the lens groups, for the zoom lens system according to the present invention; and

FIG. 15 is another schematic view of the lens-group moving paths, without the switching movement of the lens groups, for the zoom lens system according to the present invention.

### DESCRIPTION OF THE PREFERRED EMBODIMENTS

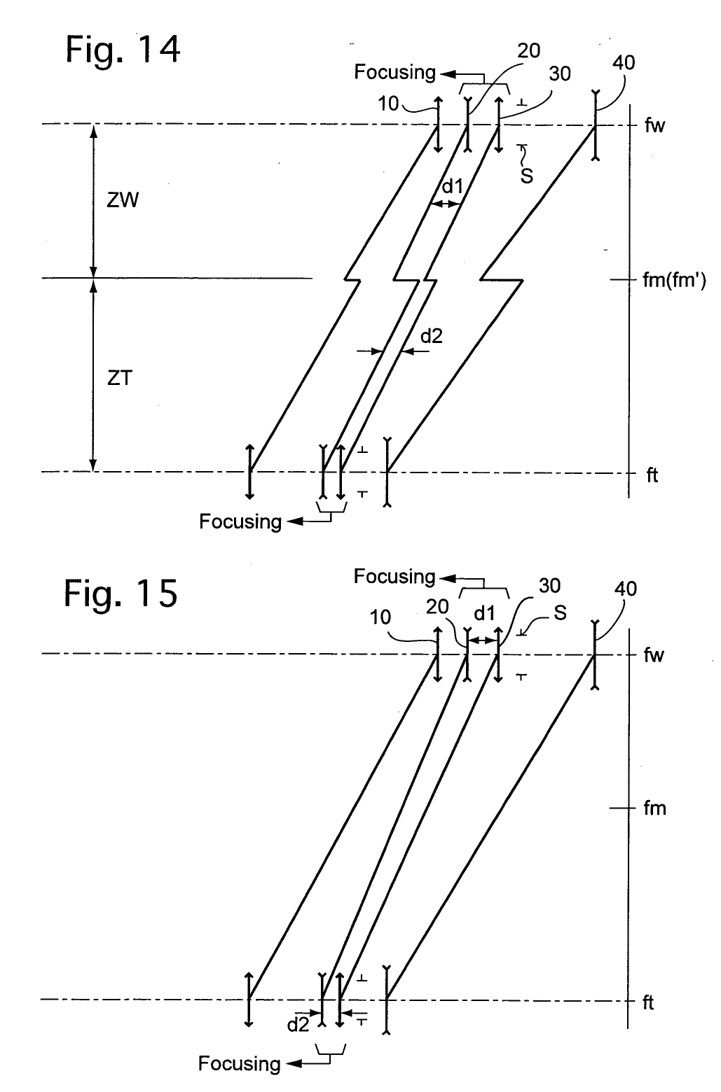

As shown in the lens-group moving paths of FIGS. 14 and 15, the four-lens-group zoom lens system for a compact camera includes a positive first lens group 10, a negative second lens group 20, a positive third lens group 30, and a negative fourth lens group 40, in this order from the object; and zooming is performed by moving the first through fourth lens groups in the optical axis direction. A diaphragm S is provided between the positive third lens group 30 and the negative fourth lens group 40, and moves together with the positive third lens group 30.

FIG. 14 is an example of the lens-group moving paths having a switching movement of the lens groups at the intermediate focal lengths. According to FIG. 14, zooming from the short focal length extremity fw toward the long focal length extremity ft, the lens groups 10 through 40 are arranged to move as follows:

In a focal-length range ZW (the first focal length range; the short-focal-length side zooming range) extending from the short focal length extremity fw to the first intermediate focal length fm, the positive first lens group 10, the negative second lens group 20, the positive third lens group 30, and the negative fourth lens group 40 are moved toward the object;

At the first intermediate focal length fm (before switching), the positive first lens group 10, the negative second lens group 20, the positive third lens group 30, and the negative fourth lens group 40 are moved towards the image plane by a predetermined distance, so that the first intermediate focal length fm is changed to the second intermediate focal length fm′ (after switching);

In a focal-length range ZT (the second focal length range; the long-focal-length side zooming range) extending from the second intermediate focal length fm′ to the long focal length extremity ft, the positive first lens group 10, the negative second lens group 20, the positive third lens group 30, and the negative fourth lens group 40 are moved towards the object;

In the focal-length range ZW, the negative second lens group 20 and the positive third lens group 30 maintains a predetermined distance d1 (the first state);

At the first intermediate focal length fm, the distance d1 between the negative second lens group 20 and the positive third lens group 30 is reduced; and

In the focal-length range ZT, the negative second lens group 20 and the positive third lens group 30 maintain the shortened distance d2 (the second state).

The first intermediate focal length fm belongs to the first focal length range ZW.

The second intermediate focal length fm′ is determined after the following movement of the lens groups is completed:

(i) the positive first lens group 10 and the negative fourth lens group 40 are moved from the positions thereof, corresponding to the first intermediate focal length fm, toward the image; and

(ii) the negative second lens group 20 and the positive third lens group 30 reduce the distance therebetween, while the negative second lens group 20 and the positive third lens group 30 are respectively moved toward the image.

Upon zooming, the diaphragms moves together with the positive third lens group 30.

The lens-group moving paths, before and after the switching movement, for the first through fourth lens groups shown in FIG. 14 are simply depicted as straight lines. It should however be noted that actual lens-group moving paths are not necessarily straight lines. Furthermore, focusing is performed by integrally moving the negative second lens group 20 the positive third lens group 30 regardless of the focal length ranges.

The lens-group moving paths have discontinuities at the first intermediate focal length fm and the second intermediate focal length fm′; however, by adequately determining the positions of the positive first lens group 10, the negative second lens group 20, the positive third lens group 30, and the negative fourth lens group 40 respectively at the short focal length extremity fw, the first intermediate focal length fm, the second intermediate focal length fm′ and the long focal length extremity ft, solutions by which an image is correctly formed on the image plane can be obtained.

According to the lens-group moving paths with these solutions, the position of each lens group can be precisely controlled, compared with the lens-group moving paths of FIG. 20 to be discussed below by which the lens groups are continually moved. Consequently, a zoom lens system which is miniaturized and has a higher zoom ratio can be obtained.

Furthermore, positions for stopping each lens group can be determined in a stepwise manner along the lens-group moving paths of FIG. 14. In an actual mechanical arrangement of the zoom lens system, each lens group can be stopped at predetermined positions according to the above-explained stepwise manner. For example, if positions at which each lens group is to be stopped are determined by appropriately selecting positions before and after the first (second) intermediate focal length fm (fm′), i.e., not at the positions just corresponding to the first (second) intermediate focal length fm (fm′), the above discontinuities can be connected by smooth curved lines. Moreover, if a stopping position closest to the second intermediate focal length fm′ in the long-focal-length side zooming range ZT is set closer to the object from a stopping position closest to the first intermediate focal length fm in the short-focal-length side zooming range ZW, precision on the movement of the lens groups can be enhanced, since a U-turn movement is prevented in actual moving paths.

FIG. 15 shows an example of the lens-group moving paths without intermediate-switching of the focal lengths. Upon zooming from the short focal length extremity toward the long focal length extremity, all the lens groups move toward the object, while the distances therebetween are varied. The diaphragm S is provided between the positive third lens group 30 and the negative fourth lens group 40, and moves together with the positive third lens group 30. The lens-group moving paths of FIG. 15 are also simply depicted as straight lines; however actual lens-group moving paths are not necessarily straight lines. Furthermore, focusing is performed by integrally moving the negative second lens group 20 and the positive third lens group 30 regardless of the focal length ranges.

Even if the lens-group moving paths of FIG. 15 are employed, the position of each lens group can be precisely controlled, so that a higher zoom ratio and further miniaturization can be achieved.

Condition (1) specifies the amount of change in the distance between the positive first lens group 10 and the negative second lens group 20 upon zooming. By satisfying this condition, the zooming effect of the positive first lens group 10 to the positive third lens group 30 becomes larger, while the traveling distance of the negative fourth lens group 40 is reduced. Consequently, the f-number at the long focal length extremity can be secured.

If (D_{12T}−D_{12W})/f_{W} exceeds the upper limit of condition (1), the traveling distance of the positive first lens group 10 becomes longer, so that further miniaturization becomes difficult.

If (D_{12T}−D_{12W})/f_{W} exceeds the lower limit of condition (1), the zooming effect of the positive first lens group 10 to the positive third lens group 30 becomes smaller, and the traveling distance of the negative fourth lens group 40 becomes longer. Consequently, it becomes difficult to secure the f-number at the long focal length extremity.

Condition (2) specifies the traveling distances of the positive first lens group 10 and the negative fourth lens group 40. By satisfying this condition, zooming can be performed by using the combined focal length of the positive first lens group to the positive third lens group 30.

If ΔX_{1G}/ΔX_{4G} exceeds the upper limit of condition (2), the traveling distance of the positive first lens group 10 becomes longer, so that the overall length of the zoom lens system becomes longer.

If ΔX_{1G}/ΔX_{4G} exceeds the lower limit of condition (2), the traveling distance of the negative fourth lens group 40 cannot be made shorter, so that the overall length of the zoom lens system becomes longer.

Condition (3) specifies the ratio of the focal length of the entire the zoom lens system at the short focal length extremity to the focal length of the positive first lens group 10, for the purpose of achieving further miniaturization. By satisfying this condition, aberrations occurred in the positive first lens group 10 can be reduced, and fluctuation of aberrations from the short focal length extremity to the long focal length extremity can be reduced.

If the focal length of the positive first lens group 10 becomes shorter to the extent that f_{W}/f_{1G} exceeds the upper limit of condition (3), aberrations occurred in the positive first lens group 10 become larger, so that the correcting of aberrations becomes difficult.

If the focal length of the positive first lens group 10 becomes longer to the extent that f_{W}/f_{1G} exceeds the lower limit of condition (3), the traveling distance of the positive first lens group 10 becomes longer, and further miniaturization cannot be achieved.

Condition (4) specifies the combined focal length of the negative second lens group 20 and the positive third lens group 30. By satisfying this condition, a suitable zoom ratio can be secured.

If (D_{23W}−D_{23T})/f_{W} exceeds the upper limit of condition (4), the zooming effect of both the negative second lens group 20 and the positive third lens group 30 becomes too large, so that aberrations occurred in each lens group become larger.

If (D_{23W}−D_{23T})/f_{W} exceeds the lower limit of condition (4), the zooming effect of both the negative second lens group 20 and the positive third lens group 30 becomes smaller, so that it becomes difficult to secure the zoom ratio.

Condition (5) specifies the amount of change in the distance between the negative second lens group 20 and the positive third lens group 30 upon zooming. By satisfying this condition, a suitable zoom ratio can be secured, while the overall length of the zoom lens system can be reduced.

If (f_{23T}/f_{23W})/(f_{T}/f_{W}) exceeds the upper limit of condition (5), the amount of change in the distance between the negative second lens group 20 and the positive third lens group 30 upon zooming becomes larger, so that the overall length of the zoom lens system becomes longer.

If (f_{23T}/f_{23W})/(f_{T}/f_{W}) exceeds the lower limit of condition (5), the amount of change in the distance between the negative second lens group 20 and the positive third lens group 30 upon zooming becomes smaller, a desired zooming effect cannot be achieved.

Condition (6) specifies the ratio of the height of the paraxial light ray incident on the most object-side surface (first surface) of the positive first lens group 10 to the height of the same paraxial light ray incident on the most image-side of the positive third lens group 30. By satisfying this condition, the half angle-of-view of more than 35° can be secured at the short focal length extremity, and a suitable back focal distance at the short focal length extremity can also be secured.

If h_{3G}/h₁ exceeds the upper limit of condition (6), it becomes difficult to correct aberrations occurred in the positive first lens group 10 to the positive third lens group 30. Consequently, the number of lens elements has to be increased, and the size of the zoom lens system becomes larger.

If h_{3G}/h₁ exceeds the lower limit of condition (6), the back focal distance cannot be secured under the condition that the half angle-of-view of more than 35° is secured at the short focal length extremity.

Condition (7) specifies the amount of asphericity in the case where the positive third lens group 30 includes at least one aspherical surface. By satisfying this condition, spherical aberrations can be adequately corrected.

If the amount of asphericity becomes larger to the extent that ΔI_{ASP} exceeds the upper limit of condition (7), manufacture of the lens element having the aspherical surface becomes difficult.

If the amount of asphericity becomes smaller to the extent that ΔI_{ASP} exceeds the lower limit of condition (7), the amount of the correcting of spherical aberration by the aspherical surface becomes smaller, so that the correcting of aspherical aberration cannot be made sufficiently.

Condition (8) specifies the amount of asphericity in the case where the negative fourth lens group 40 includes at least one aspherical surface. By satisfying this condition, distortion can be adequately corrected.

If the amount of asphericity becomes larger to the extent that ΔV_{ASP} exceeds the upper limit of condition (8), manufacture of the lens element having the aspherical surface becomes difficult.

If the amount of asphericity becomes smaller to the extent that ΔV_{ASP} exceeds the lower limit of condition (8), the amount of the correcting of distortion by the aspherical surface becomes smaller, so that the correcting of distortion cannot be made sufficiently.

Specific numerical data of the embodiments will be described hereinafter. In the diagrams of chromatic aberration (axial chromatic aberration) represented by spherical aberration, the solid line and the two types of dotted lines respectively indicate spherical aberrations with respect to the d, g and C lines. Also, in the diagrams of lateral chromatic aberration, the two types of dotted lines respectively indicate magnification with respect to the g and C lines; however, the d line as the base line coincides with the ordinate. In the diagrams of astigmatism, S designates the sagittal image, and M designates the meridional image. In the tables, F_{NO} designates the f-number, f designates the focal length of the entire zoom lens system, f_{B} designates the back focal distance, w designates the half angle-of-view (°), r designates the radius of curvature, d designates the lens-element thickness or distance between lens elements, N_{d} designates the refractive index of the d-line, and v designates the Abbe number.

In addition to the above, an aspherical surface which is symmetrical with respect to the optical axis is defined as follows:

x=cy²/(1+[1−{1+K}c²y²]^{1/2})+A4y⁴+A6y⁶+A8y⁸+A10y¹⁰ . . .

wherein:

c designates a curvature of the aspherical vertex (1/r);

y designates a distance from the optical axis;

K designates the conic coefficient; and

A4 designates a fourth-order aspherical coefficient;

A6 designates a sixth-order aspherical coefficient;

A8 designates a eighth-order aspherical coefficient; and

A10 designates a tenth-order aspherical coefficient.

Furthermore, the relationship between the aspherical coefficients and aberration coefficients is discussed as follows:

1. The shape of an aspherical surface is defined as follows:

x=cy²/(1+[1{1+K}c²y²]^{1/2})+A4y⁴+A6y⁶+A8y⁸+A10y¹⁰ . . .

wherein:

x designates a distance from a tangent plane of an aspherical vertex;

y designates a distance from the optical axis;

c designates a curvature of the aspherical vertex (1/r),

K designates a conic constant;

2. In this equation, to obtain the aberration coefficients, the following substitution is made to replace K with “0” (Bi=Ai when K=0).

B4=A4+Kc³/8;

B6=A6+(K²+2K)c⁵/16;

B8=A8+5(K³+3K²+3K)c⁷/128

B10=A10+7(K⁴+4K³+6K²+4K)c⁹/256; and therefore, the following equation is obtained:

x=cy²/[1+[1−c²y²]^{1/2}]+B4y⁴+B6y⁶+B8y⁸+B10y¹⁰+. . .

3. Furthermore, in order to normalize the focal length f to 1.0, the followings are considered:

X=x/f; Y=y/f; C=f*c;

α4=f³B4; α6=f⁵B6; α8=f⁷B8; α10=f⁹B10

Accordingly, the following equation is obtained.

X=CY²/[1+[1−C²Y²]^{1/2}]+α4Y⁴+α6Y⁶+α8Y⁸+α10Y¹⁰ . . .

4. Φ=8(N′−N)α4 is defined, and the third aberration coefficients are defined as follows:

I designates the spherical aberration coefficient;

II designates the coma coefficient;

III designates the astigmatism coefficient;

IV designates the curvature coefficient of the sagittal image surface; and

V designates a distortion coefficient; and therefore, the influence of the fourth-order aspherical-surface coefficient (α4) on each aberration coefficient is defined as:

ΔI=h⁴Φ

ΔII=h³kΦ

ΔIII=h²k²Φ

ΔIV=h²k²Φ

ΔV=hk³Φ

wherein

h1 designates the height at which a paraxial axial light ray strikes the first surface of the lens system including the aspherical surface;

h designates the height at which the paraxial axial light ray strikes the aspherical surface when the height h1 is 1;

k1 designates the height at which a paraxial off-axis ray, passing through the center of the entrance pupil, strikes the first surface of the lens system including the aspherical surface;

k designates the height at which the paraxial off-axis light ray strikes the aspherical surface when the height k1 is −1;

N′ designates the refractive index of a medium on the side of the image with respect to the aspherical surface; and

N designates the refractive index of a medium on the side of the object with respect to the aspherical surface.

[Embodiment 1]

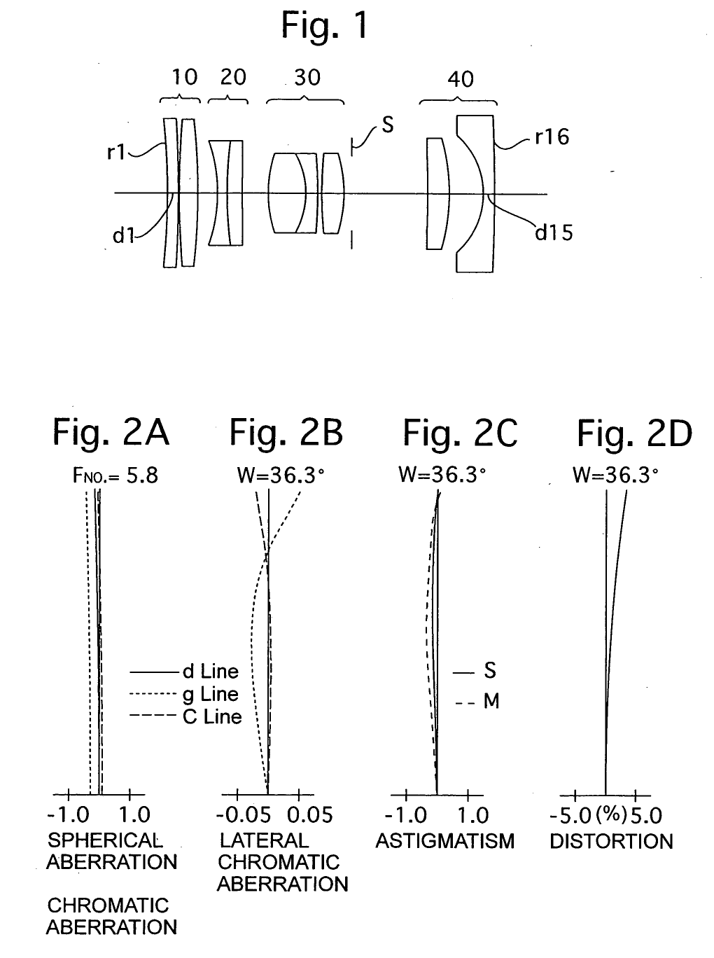

FIGS. 1 through 4D show the first embodiment of the zoom lens system.

The first embodiment is applied to the zoom lens system in which the lens groups are arranged to move according to the lens-group moving paths of FIG. 15.

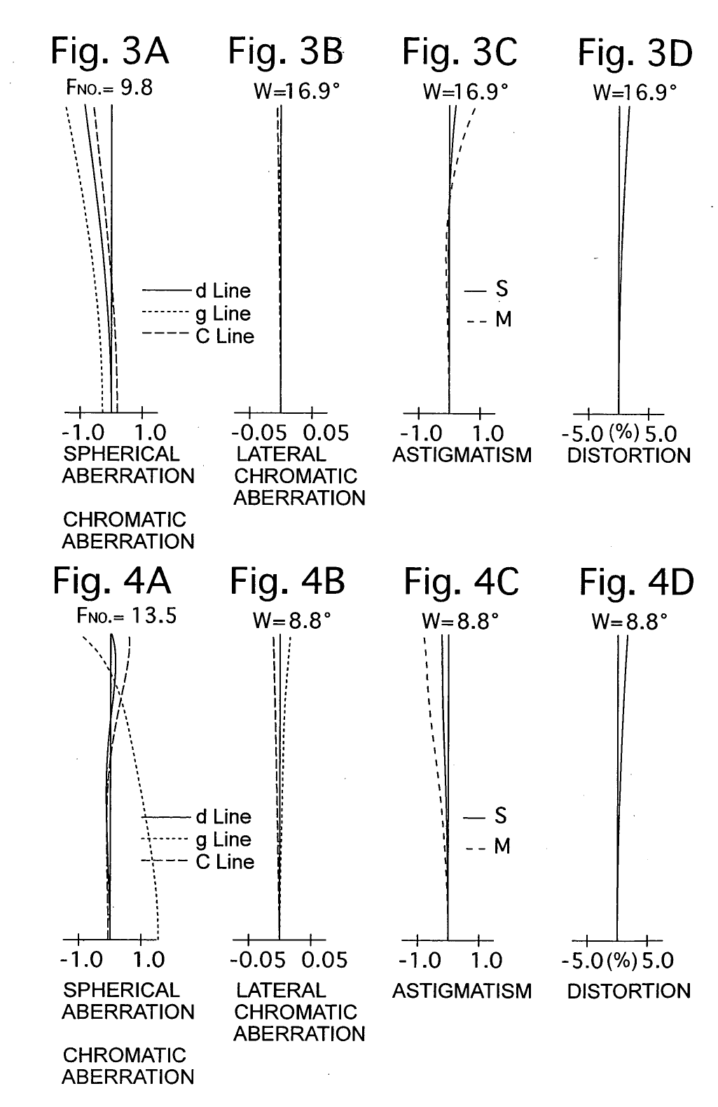

FIG. 1 is the lens arrangement of the zoom lens system according to the first embodiment. FIGS. 2A through 2D show aberrations occurred in the zoom lens system shown in FIG. 1 at the short focal length extremity. FIGS. 3A through 3D show aberrations occurred in the zoom lens system shown in FIG. 1 at the intermediate focal length when the lens groups are moved along the lens-group moving paths shown in FIG. 15. FIGS. 4A through 4D show aberrations occurred in the zoom lens system shown in FIG. 1 at the long focal length extremity. Table 1 shows the numerical data thereof.

Surface Nos. 1 through 4 represent the positive first lens group 10, surface Nos. 5 through 7 represent the negative second lens group 20, surface Nos. 8 through 12 represent the positive third lens group 30, surface Nos. 13 through 16 represent the negative fourth lens group 40. The diaphragm S is provided 1.00 mm behind (on the image side) the third lens group 30 (surface No. 12).

The positive first lens group 10 includes a negative lens element and a positive lens element, in this order from the object.

The negative second lens group 20 includes cemented lens elements having a biconcave negative lens element and a positive lens element, in this order from the object.

The positive third lens group 30 includes cemented lens elements having a biconvex positive lens element and a negative lens element, and a positive lens element, in this order from the object.

The negative fourth lens group 40 includes a positive lens element and a negative lens element, in this order from the object.

TABLE 1

| | | | | |
|---|---|---|---|---|
| FNo = 1: | 5.8 | 9.8 | 13.5 | |
| f = | 28.50 | 70.03 | 138.05 | (Zoom Ratio = 4.84) |
| W = | 36.3 | 16.9 | 8.8 | |
| f_{B} = | 8.07 | 40.40 | 77.56 | |
| D4 = | 2.50 | 8.44 | 24.12 | |
| D7 = | 3.30 | 2.15 | 0.30 | |
| D12 = | 10.64 | 4.13 | 2.45 | |

| Surf.No. | r | d | Nd | ν |
|---|---|---|---|---|
| 1 | −92.958 | 1.40 | 1.84666 | 23.8 |
| 2 | −154.049 | 0.10 | | |
| 3 | 114.801 | 2.33 | 1.48749 | 70.2 |
| 4 | −83.768 | D4 | | |
| 5 | −19.399 | 1.20 | 1.74330 | 49.3 |
| 6 | 51.729 | 1.91 | 1.80459 | 25.5 |
| 7 | 467.552 | D7 | | |
| 8 | 15.561 | 4.74 | 1.48749 | 70.2 |
| 9 | −10.306 | 1.50 | 1.84499 | 34.3 |
| 10 | −59.503 | 0.50 | | |
| 11 | 53.413 | 2.83 | 1.72750 | 40.3 |
| 12* | −16.037 | D12 | | |
| 13* | −80.438 | 2.69 | 1.58547 | 29.9 |
| 14 | −25.471 | 4.28 | | |
| 15 | −9.889 | 1.40 | 1.79032 | 47.3 |
| 16 | −232.353 | — | | |

*designates the aspherical surface which is rotationally symmetrical with respect to the optical axis.

Aspherical surface data (the aspherical surface coefficients not indicated are zero (0.00)):

| Surf.No. | K | A4 | A6 | A8 |
|---|---|---|---|---|
| 12 | 0.00 | 0.79192 × 10⁻⁴ | −0.13087 × 10⁻⁶ | 0.62915 × 10⁻⁹ |
| 13 | 0.00 | 0.77458 × 10⁻⁴ | −0.25249 × 10⁻⁶ | 0.75658 × 10⁻⁸ |

[Embodiment 2]

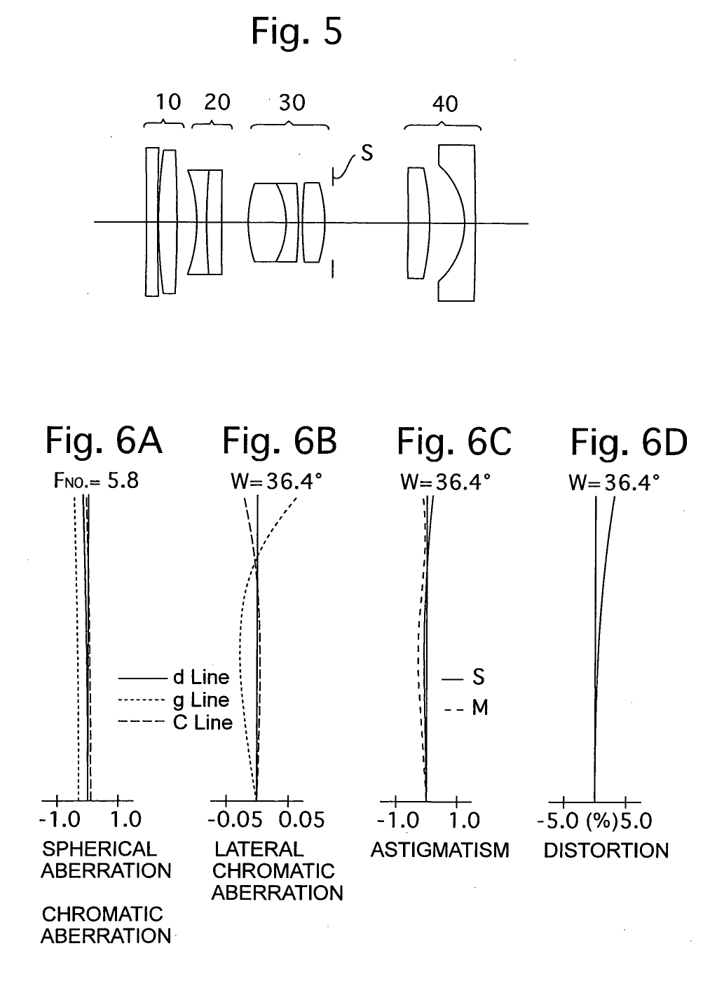

FIGS. 5 through 8D show the second embodiment of the zoom lens system.

Similar to the first embodiment, the second embodiment is applied to the zoom lens system in which the lens groups are arranged to move according to the lens-group moving paths of FIG. 15.

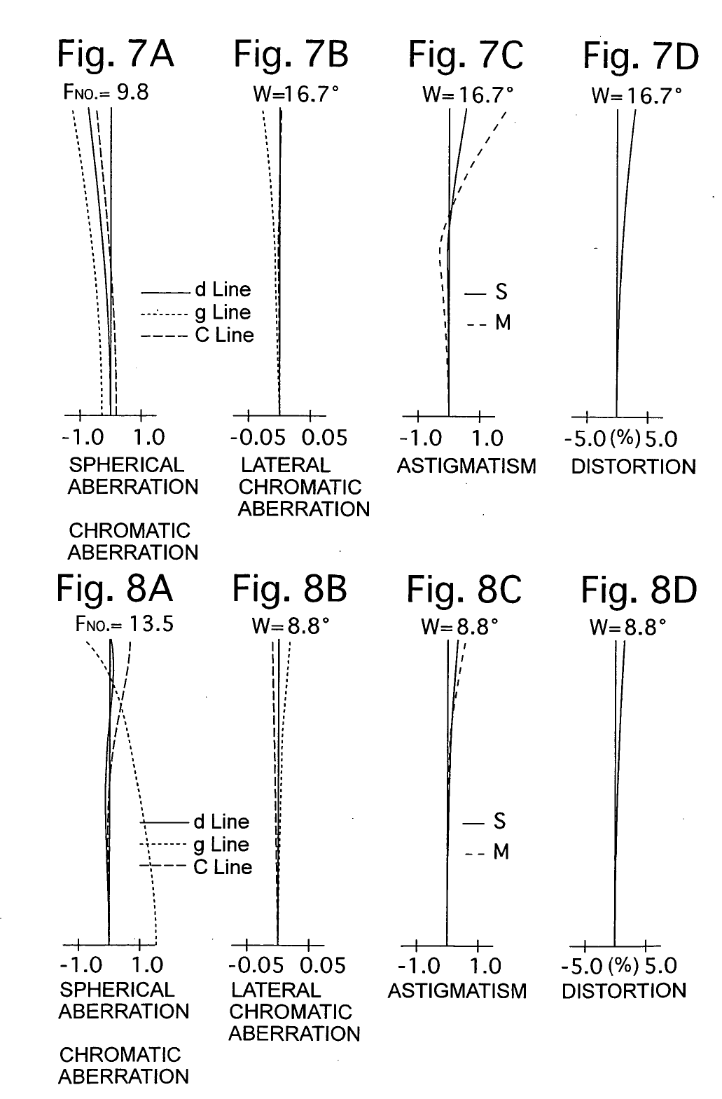

FIG. 5 is the lens arrangement of the zoom lens system according to the second embodiment. FIGS. 6A through 6D show aberrations occurred in the zoom lens system shown in FIG. 5 at the short focal length extremity. FIGS. 7A through 7D show aberrations occurred in the zoom lens system shown in FIG. 5 at the intermediate focal length when the lens groups are moved along the lens-group moving paths shown in FIG. 15. FIGS. 8A through 8D show aberrations occurred in the zoom lens system shown in FIG. 5 at the long focal length extremity. Table 2 shows the numerical data thereof. The basic lens arrangement of the zoom lens system according to the second embodiment is the same as that of the first embodiment; and the diaphragm S is provided 1.00 mm behind (on the image side) the third lens group 30 (surface No. 12).

TABLE 2

| | | | | |
|---|---|---|---|---|
| FNo = 1: | 5.8 | 9.8 | 13.5 | |
| f = | 28.50 | 70.01 | 138.00 | (Zoom Ratio = 4.84) |
| W = | 36.4 | 16.7 | 8.8 | |
| f_{B} = | 8.07 | 36.95 | 77.03 | |
| D4 = | 2.47 | 18.03 | 24.51 | |
| D7 = | 3.38 | 2.26 | 0.30 | |
| D12 = | 10.58 | 4.11 | 2.33 | |

| Surf.No. | r | d | Nd | ν |
|---|---|---|---|---|
| 1 | −458.009 | 1.40 | 1.84666 | 23.8 |
| 2 | 531.404 | 0.10 | | |
| 3 | 68.179 | 2.33 | 1.48749 | 70.2 |
| 4 | −182.513 | D4 | | |
| 5 | −19.418 | 1.20 | 1.75832 | 52.1 |
| 6 | 76.625 | 1.91 | 1.80518 | 25.4 |
| 7 | 918.969 | D7 | | |
| 8 | 16.037 | 4.74 | 1.48749 | 70.2 |
| 9 | −10.370 | 1.50 | 1.84499 | 34.3 |
| 10 | −56.910 | 0.50 | | |
| 11 | 51.746 | 2.83 | 1.72750 | 40.3 |
| 12* | −16.200 | D12 | | |
| 13* | −118.311 | 2.69 | 1.68893 | 31.1 |
| 14* | −31.858 | 4.49 | | |
| 15 | −9.889 | 1.40 | 1.78137 | 48.4 |
| 16 | −304.227 | — | | |

*designates the aspherical surface which is rotationally symmetrical with respect to the optical axis.

Aspherical surface data (the aspherical surface coefficients not indicated are zero (0.00)):

| Surf.No. | K | A4 | A6 | A8 |
|---|---|---|---|---|
| 12 | 0.00 | 0.76841 × 10⁻⁴ | −0.11985 × 10⁻⁶ | 0.87894 × 10⁻⁹ |
| 13 | 0.00 | 0.61460 × 10⁻⁴ | 0.79615 × 10⁻⁷ | 0.73119 × 10⁻⁸ |
| 14 | 0.00 | −0.80921 × 10⁻⁵ | 0.35557 × 10⁻⁶ | — |

[Embodiment 3]

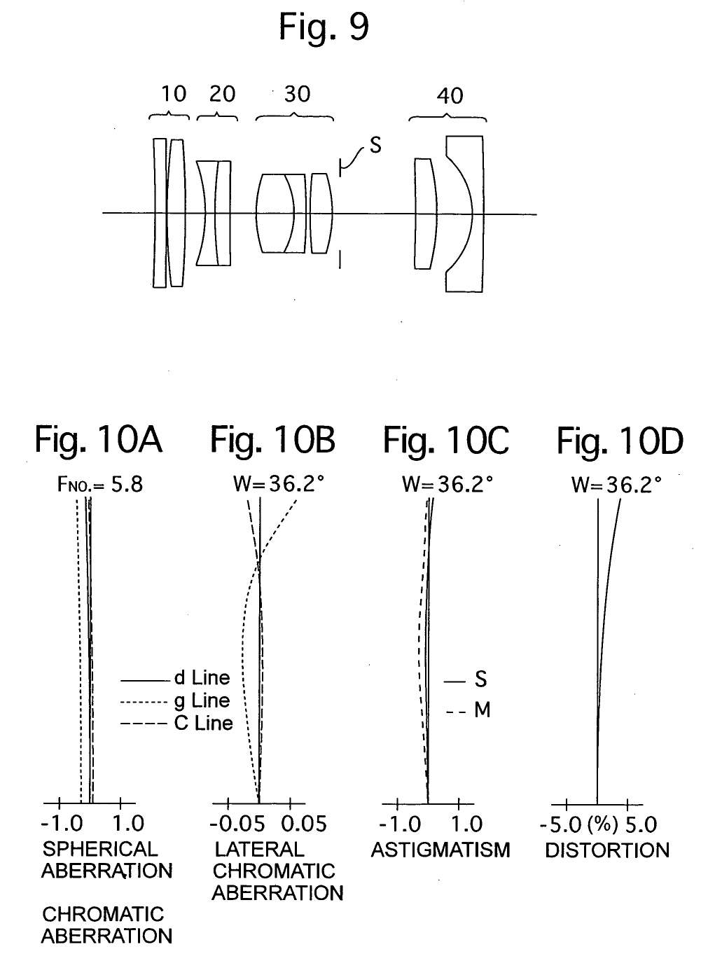

FIGS. 9 through 13D show the third embodiment of the zoom lens system.

The third embodiment is applied to the zoom lens system in which the lens groups are arranged to move according to the lens-group moving paths of FIG. 14.

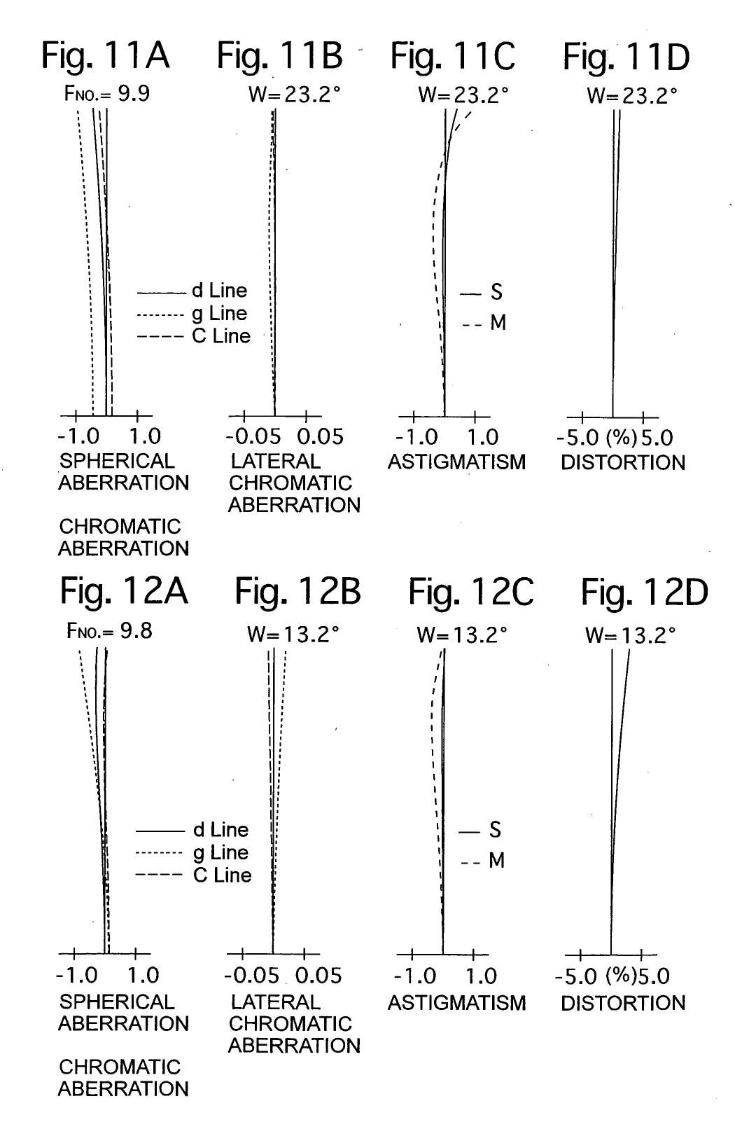

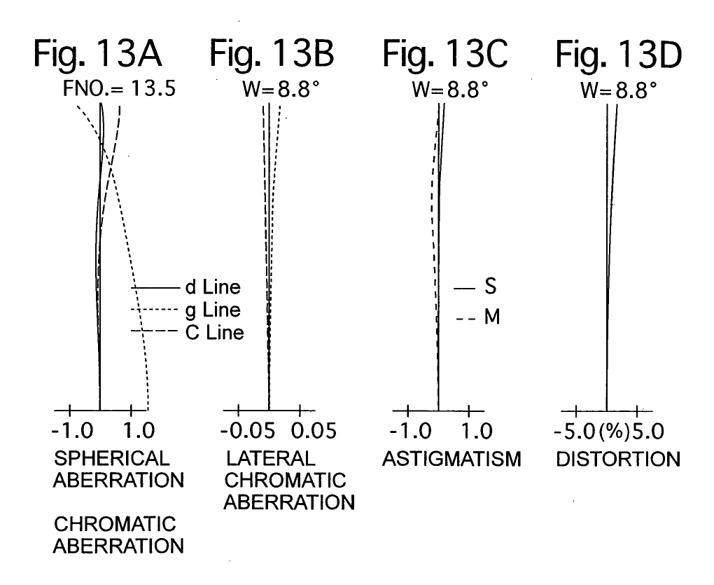

FIG. 9 is the lens arrangement of the zoom lens system according to the third embodiment. FIGS. 10A through 10D show aberrations occurred in the zoom lens system shown in FIG. 9 at the short focal length extremity. FIGS. 11A through 11D show aberrations occurred in the zoom lens system shown in FIG. 9 at the first (before switching) intermediate focal length in the short-focal-length side zooming range when the lens groups are moved along the lens-group moving paths shown in FIG. 14. FIGS. 12A through 12D show aberrations occurred in the zoom lens system shown in FIG. 9 at the second (after switching) intermediate focal length in the long-focal-length side zooming range when the lens groups are moved along the lens-group moving paths shown in FIG. 14. FIGS. 13A through 13D show aberrations occurred in the zoom lens system shown in FIG. 9 at the long focal length extremity. Table 3 shows the numerical data thereof.

The designators f, W, f_{B}, D4, D7 and D10 in Table 3 represent numerical data, arranged in the order of fw-fm-fm′-ft, when the lens groups of the zoom lens system are moved according to the lens-group moving paths of FIG. 14.

The negative second lens group 20 and the positive third lens group 30 maintain the predetermined distance d1 (=3.30 mm) in the short-focal-length side zooming range ZW, and maintains the shortened distance d2 (=0.30 mm) in the long-focal-length side zooming range ZT.

The basic lens arrangement of the zoom lens system according to the third embodiment is the same as that of the first embodiment; and the diaphragm S is provided 1.00 mm behind (on the image side) the third lens group 30 (surface No. 12).

TABLE 3

| | | | | | |
|---|---|---|---|---|---|
| FNo = | 1:5.8 | 9.9 | 9.8 | 13.5 | |
| f | 28.50 | 50.00 | 90.00 | 138.00 | (Zoom Ratio = 4.84) |
| W | 36.2 | 23.2 | 13.2 | 8.8 | |
| f_{B} = | 8.07 | 26.42 | 47.66 | 76.36 | |
| D4 = | 2.50 | 6.18 | 15.92 | 25.09 | |
| D7 = | 3.30 | 3.30 | 0.30 | 0.30 | |
| D12 = | 10.62 | 5.37 | 4.17 | 2.42 | |

| Surf.No. | r | d | Nd | ν |
|---|---|---|---|---|
| 1 | −200.379 | 1.40 | 1.84666 | 23.8 |
| 2 | −1172.750 | 0.10 | | |
| 3 | 80.238 | 2.33 | 1.48749 | 70.2 |
| 4 | −122.318 | D4 | | |
| 5 | −19.374 | 1.20 | 1.74330 | 49.3 |
| 6 | 51.185 | 1.91 | 1.80500 | 25.4 |
| 7 | 315.154 | D7 | | |
| 8 | 15.870 | 4.74 | 1.48749 | 70.2 |
| 9 | −10.258 | 1.50 | 1.84499 | 34.2 |
| 10 | −59.477 | 0.50 | | |
| 11 | 49.920 | 2.83 | 1.72750 | 40.3 |
| 12* | −15.982 | D12 | | |
| 13* | −86.831 | 2.69 | 1.68893 | 31.1 |
| 14* | −29.147 | 4.48 | | |
| 15 | −9.889 | 1.40 | 1.78149 | 48.4 |
| 16 | −309.391 | — | | |

*designates the aspherical surface which is rotationally symmetrical with respect to the optical axis.

Aspherical surface data (the aspherical surface coefficients not indicated are zero (0.00)):

| Surf.No. | K | A4 | A6 | A8 |
|---|---|---|---|---|
| 12 | 0.00 | 0.79150 × 10⁻⁴ | −0.11000 × 10⁻⁶ | 0.76415 × 10⁻⁹ |
| 13 | 0.00 | 0.61801 × 10⁻⁴ | −0.16228 × 10⁻⁷ | 0.70538 × 10⁻⁸ |
| 14 | 0.00 | −0.59867 × 10⁻⁵ | 0.22744 × 10⁻⁶ | — |

The numerical values of each embodiment for each condition are shown in Table 4.

TABLE 4

| | Embodiment 1 | Embodiment 2 | Embodiment 3 |
|---|---|---|---|
| Condition (1) | 0.76 | 0.77 | 0.77 |
| Condition (2) | 1.15 | 1.16 | 1.17 |
| Condition (3) | 0.19 | 0.18 | 0.19 |
| Condition (4) | 0.11 | 0.11 | 0.11 |
| Condition (5) | 0.24 | 0.25 | 0.25 |
| Condition (6) | 1.18 | 1.18 | 1.18 |
| Condition (7) | −20.60 | −20.03 | −20.76 |
| Condition (8) | 0.15 | 0.16 | 0.15 |

As can be understood from Table 4, the numerical values of the first through third embodiments satisfy conditions (1) through (8). Furthermore, as shown in the aberration diagrams, the various aberrations at each focal length are adequately corrected.

According to the above description, a zoom lens system, for a lens-shutter camera with a retractable lens barrel, having a zoom ratio Z (=fT/fW) of more than 4.5, and in particular, having the half angle-of-view of more than 35° at the short focal length extremity, can be achieved.

What is claimed is:

1. A zoom lens system comprising a positive first lens group, a negative second lens group, a positive third lens group, and a negative fourth lens group, in this order from an object,
wherein zooming is performed by moving each of said positive first through said negative fourth lens groups along the optical axis;
wherein said zoom lens system satisfies the following conditions:
0.5<(D_{12T}−D_{12W})/f_{W}<1.0
1.0<ΔX_{1G}/ΔX_{4G}<1.5
wherein
D_{12T} designates the axial distance between said positive first lens group and said negative second lens group at the long focal length extremity;
D_{12W} designates the axial distance between said positive first lens group and said negative second lens group at the short focal length extremity;
f_{W} designates the focal length of the entire the zoom lens system at the short focal length extremity;
ΔX_{1G} designates the traveling distance of said positive first lens group from the short focal length extremity to the long focal length extremity; and
ΔX_{4G} designates the traveling distance of said negative fourth lens group from the short focal length extremity to the long focal length extremity

2. The zoom lens system according to claim 1, satisfying the following condition:
0.1<f_{W}/f_{1G<}0.3
wherein
f_{1G} designates the focal length of said positive first lens group.

3. The zoom lens system according to claim 1, satisfying the following condition:
0.05<(D_{23W}−D_{23T})/f_{W<}0.15
wherein
D₂₃, designates the axial distance between said negative second lens group and said positive third lens group at the short focal length extremity; and
D_{23T} designates the axial distance between said negative second and said positive third lens group at the long focal length extremity.

4. The zoom lens system according to claim 1, satisfying the following condition:
0.1<(f_{23T}/f_{23W})/(f_{T}/f_{W})<0.4
wherein
f_{23T} designates the combined focal length of said negative second lens group and said positive third lens group at the long focal length extremity;
f_{23W} designates the combined focal length of said negative second lens group and said positive third lens group at the short focal length extremity; and
f_{T} designates the focal length of the entire the zoom lens system at the long focal length extremity.

5. The zoom lens system according to claim 1, satisfying the following condition:
1.15<h_{3G}/h₁<1.30
wherein
h₁ designates the height of paraxial light ray, from the optical axis, being incident on the most object-side surface of said positive first lens group at the short focal length extremity; and
h_{3G} designates the height of the paraxial light ray, from the optical axis, being incident on the most image-side surface of said positive third lens group at the short focal length extremity, when the paraxial light ray has been incident at the height of h1 on the most object-side surface of said positive first lens group.

6. The zoom lens system according to claim 1, wherein said positive third lens group comprises at least one aspherical surface that satisfies the following condition:
−30<ΔI_{ASP}<−10
wherein
ΔV_{ASP} designates the amount of change of the spherical aberration coefficient due to the aspherical surface in said positive third lens group under the condition that the focal length at the short focal length extremity is converted to 1.0.

7. The zoom lens system according to claim 1, wherein said negative fourth lens group comprises at least one aspherical surface that satisfies the following condition:
0<ΔV_{ASP}<3
wherein
ΔV_{ASP} designates the amount of change of the distortion coefficient due to the aspherical surface in said negative fourth lens group under the condition that the focal length at the short focal length extremity is converted to 1.0.
